(19) United States
(12) Patent Application Publication
(10) Pub. No.: US 2015/0109411 A1
(43) Pub. Date: Apr. 23, 2015

(54) IMAGE PLAYBACK APPARATUS FOR 3DTV AND METHOD PERFORMED BY THE APPARATUS

(71) Applicants: Electronics and Telecommunications Research Institute, Daejeon (KR); KOOKMIN UNIVERSITY INDUSTRY ACADEMY COOPERATION FOUNDATION, Seoul (KR); Hidea Solutions Co., Ltd, Seoul (KR)

(72) Inventors: Joo Young Lee, Daejeon (KR); Sung Hoon Kim, Daejeon (KR); Hyon Gon Choo, Daejeon (KR); Jin Soo Choi, Daejeon (KR); Jin Woong Kim, Daejeon (KR); Suk Jin Hong, Seoul (KR); Jin Suk Kwak, Daejeon (KR); Min Suk Lee, Daejeon (KR); Dong Wook Kang, Seoul (KR); Kyeong Hoon Jung, Seoul (KR)

(21) Appl. No.: 14/397,125

(22) PCT Filed: Apr. 26, 2013
(86) PCT No.: PCT/KR2013/003653

§ 371 Date: Oct. 24, 2014

(30) Foreign Application Priority Data
Apr. 26, 2012 (KR) 10-2012-0044061
Apr. 26, 2013 (KR) 10-2013-0046782

(51) Int. Cl. H04N 13/00

(52) U.S. Cl. CPC H04N 13/0051; H04N 13/0062; H04N 2013/0096
USPC 348/43

(57) ABSTRACT

An image reproduction apparatus for a 3DTV and a processing method by the apparatus are disclosed. The image reproduction apparatus may determine an output time of a buffer to store a left image stream and a right image stream for a 3D image. The image reproduction apparatus may determine a buffer size or a buffer delay time using a reception time difference between the left image stream and the right image stream. Further, the image reproduction apparatus may correct a reference clock or a timestamp using the reception time difference between the left image stream and the right image stream.

### TECHNICAL FIELD

The present invention relates to an image reproduction apparatus for a three-dimensional television (3DTV) and a processing method by the same, and more particularly to an apparatus and a method of efficiently processing a buffer for synchronization of a main image stream and an additional image stream transmitted via different paths.

### BACKGROUND ART

In a convention hybrid three-dimensional television (3DTV), a main image and an additional image are needed to present a 3D image. Here, the main image, which is for a high-definition (HD) two-dimensional (2D) stationary broadcast, is encoded in accordance with Moving Picture Experts Group-2 (MPEG-2) and transmitted via a stationary broadcast network. The additional image, which is for a 2D mobile broadcast, is encoded in accordance with Advance Video Coding (AVC) and transmitted via an Internet Protocol (IP) network. That is, the main image and the additional image are transmitted based on different kinds of transmission protocols. The 3DTV generates a 3D image using the main image and the additional image and reproduces the 3D image. Here, the main image is set as a left image for generation of the 3D image, while the additional image is set as a right image for generation of the 3D image.

The main image and the additional image for the 3D image are transmitted via different transmission protocols and thus have different timing models. In detail, a presentation timestamp (PTS)-based timing model in accordance with MPEG-2 is used for the main image corresponding to the left image, while a real-time transport protocol (RTP)-based timing model is used for the additional image corresponding to the right image. That is, since the main image and the additional image use different timing models, an image reproduction apparatus to present a 3DTV sets a timestamp offset between the PTS of the main image and the RTP timestamp of the additional image to be presented simultaneously at an arbitrary point of time as synchronization information and determines time points to present the main image and the additional image using the synchronization information.

Here, the image reproduction apparatus does not provide separate buffer management and control models and thus faces problems about efficiency in using buffers and minimization of synchronization delay time. Meanwhile, the image reproduction apparatus includes a renderer buffer, which occupies an overwhelmingly large buffer capacity to store a stream for a preset period of time as compared with an elementary stream (ES) buffer.

Thus, a method is required to efficiently manage a buffer in the image reproduction apparatus when left and right images are not simultaneously received but there is a delay in receiving the left image the right image.

### DISCLOSURE OF INVENTION

Technical Goals

An aspect of the present invention provides an apparatus and a method of determining sizes of buffers to store left and right image streams using a reception time difference between the left and right image streams.

An aspect of the present invention provides an apparatus and a method of determining a buffer delay time for output times of the left and right image streams using a reception time difference between the left and right image streams.

An aspect of the present invention provides an apparatus and a method of correcting a reference clock or a timestamp using a reception time difference between the left and right image streams.

An aspect of the present invention provides an apparatus and a method of synchronizing the left image stream and the right image stream by converting timestamps based on a reference clock.

### TECHNICAL SOLUTIONS

A buffer control method of an image reproduction apparatus according to an exemplary embodiment of the present invention may include acquiring synchronization information between a left image stream and a right image stream, extracting a first timestamp of the left image stream and a second timestamp of the right image stream, calculating a reception time difference between the left image stream and the right image stream using the first timestamp, the second timestamp and the synchronization information, and determining a buffer size using the reception time difference.

The acquiring of the synchronization information may acquire synchronization information including timestamp pair information including the first timestamp of the left image stream and the second timestamp of the right image stream to be presented simultaneously at an arbitrary point of time.

The acquiring of the synchronization information may acquire synchronization information including offset information between the first timestamp of the left image stream and the second timestamp of the right image stream.

The extracting of the first timestamp of the left image stream and the second timestamp of the right image stream may extract the first timestamp and the second timestamp based on an access unit (AU) last stored among an AU of the left image stream and an AU of the right image stream received at the same time point.

The extracting of the first timestamp of the left image stream and the second timestamp of the right image stream may extract the first timestamp of the left image stream and the second timestamp of the right image stream extracted by demultiplexing at similar time points.

The calculating of the reception time difference may calculate a reception time difference using a timestamp difference between the first timestamp and the second timestamp when the left image stream and the right image stream use the same reference clock, and convert one of the first timestamp and the second timestamp using the synchronization information and calculates a reception time difference using the timestamp difference between the first timestamp and the second timestamp when the left image stream and the right image stream use different reference clocks or a random offset is applied.

The determining of the buffer size may calculate a number of frames delayed between the left image stream and the right image stream using a number of AUs stored in a buffer, the reception time difference and frame rates of the image streams and determine the buffer size dynamically set up based on the calculated number of frames.

The determining of the buffer size may determine the buffer size using a constant bit rate of the left image stream or the right image stream and the reception time difference.

The determining of the buffer size may determine the buffer size using a data rate of the left image stream or the right image stream and the reception time difference.

A buffer control method of an image reproduction apparatus according to another exemplary embodiment of the present invention may include acquiring synchronization information between a left image stream and a right image stream, extracting a first timestamp of the left image stream and a second timestamp of the right image stream, calculating a reception time difference between the left image stream and the right image stream using the first timestamp, the second timestamp and the synchronization information, and determining a buffer delay time using the reception time difference.

The determining of the buffer delay time may increase a buffer delay time of the right image stream by the reception time difference when the right image stream is received before the left image stream, and increase a buffer delay time of the left image stream by the reception time difference when the left image stream is received before the right image stream.

A clock correction method of an image reproduction apparatus according to an exemplary embodiment of the present invention may include calculating a reception time difference between an AU of a left image stream and an AU of a right image stream, and correcting a reference clock signaled to one of the left image stream and the right image stream that is received before the other thereof using the reception time difference.

The correcting of the reference clock may correct the reference clock using a result of applying the reception time difference to a clock rate of the reference clock.

A timestamp correction method of an image reproduction apparatus according to an exemplary embodiment of the present invention may include calculating a reception time difference between an access unit (AU) of a left image stream and an AU of a right image stream, and correcting a first timestamp of the left image stream and a second timestamp of the right image stream using the reception time difference.

The correcting of the first timestamp of the left image stream and the second timestamp of the right image stream may correct the first timestamp of the left image stream and the second timestamp of the right image stream using a result of applying the reception time difference to a clock rate of a reference clock.

A synchronization method of an image reproduction apparatus according to an exemplary embodiment of the present invention may include acquiring synchronization information between a left image stream and a right image stream, extracting a first timestamp of the left image stream and a second timestamp of the right image stream, converting at least one of the first timestamp and the second timestamp to correspond to a reference clock using the synchronization information, and matching and synchronizing the left image stream and the right image stream based on the reference clock.

An image reproduction apparatus according to an exemplary embodiment of the present invention may include a first buffer to receive and store a left image stream, a second buffer to receive and store a right image stream, and a buffer controller to determine buffer sizes of the first buffer and the second buffer using a reception time difference between the left image stream and the right image stream, wherein the reception time difference is determined based on a first timestamp of the left image stream, a second timestamp of the right image stream and synchronization information between the left image stream and the right image stream.

An image reproduction apparatus according to another exemplary embodiment of the present invention may include a first buffer to receive and store a left image stream, a second buffer to receive and store a right image stream, and a buffer controller to determine a buffer delay time of the first buffer or the second buffer using a reception time difference between the left image stream and the right image stream, wherein the reception time difference is determined based on a first timestamp of the left image stream, a second timestamp of the right image stream and synchronization information between the left image stream and the right image stream.

An image reproduction apparatus according to still another exemplary embodiment of the present invention may include a first buffer to receive and store a left image stream, a second buffer to receive and store a right image stream, and a buffer controller (i) to correct a reference clock signaled to one of the left image stream and the right image stream that is received before the other thereof or (ii) to correct a first timestamp of the left image stream and a second timestamp of right image stream using a reception time difference between an access unit (AU) of the left image stream and an AU of the right image stream.

An image reproduction apparatus according to yet another exemplary embodiment of the present invention may include a first buffer to receive and store a left image stream, a second buffer to receive and store a right image stream, and an image synchronization unit to convert at least one of a first timestamp of the left image stream and a second timestamp of the right image stream according to a reference clock using synchronization information between the left image stream and the right image stream and to match and synchronize the left image stream and the right image stream based on the reference clock.

### Effects of the Invention

According to an exemplary embodiment of the present invention, sizes of buffers to store left and right image streams are determined using a reception time difference between the left and right image streams, thereby efficiently managing the buffers.

According to an exemplary embodiment of the present invention, a buffer delay time for output times of the left and right image streams is determined using the reception time difference between the left and right image streams, thereby minimizing a synchronization delay time.

According to an exemplary embodiment of the present invention, a reference clock or a timestamp is corrected using the reception time difference between the left and right image streams, thereby normally decoding the image streams even in the occurrence of reception time difference.

According to an exemplary embodiment of the present invention, the left image stream and the right image stream are synchronized by converting timestamps based on a reference clock, thereby providing a high-quality 3D image.

### BRIEF DESCRIPTION OF DRAWINGS

FIG. 1 illustrates an image transmission apparatus and an image reproduction apparatus according to an exemplary embodiment of the present invention;

FIG. 2 illustrates a configuration of the image reproduction apparatus according to an exemplary embodiment of the present invention;

FIG. 3 illustrates an example of the image reproduction apparatus according to an exemplary embodiment of the present invention;

FIG. 4 illustrates a process of extracting synchronization information, a first timestamp and a second timestamp according to an exemplary embodiment of the present invention;

FIG. 5 illustrates a process of controlling a buffer size according to an exemplary embodiment of the present invention;

FIG. 6 illustrates a process of correcting a reference clock or a timestamp according to an exemplary embodiment of the present invention;

FIG. 7 is a flowchart illustrating a process of controlling a buffer size according to an exemplary embodiment of the present invention;

FIG. 8 is a flowchart illustrating a process of determining a buffer delay time according to an exemplary embodiment of the present invention;

FIG. 9 is a flowchart illustrating a process of correcting a reference clock according to an exemplary embodiment of the present invention;

FIG. 10 is a flowchart illustrating a process of correcting a timestamp according to an exemplary embodiment of the present invention; and

FIG. 11 illustrates a process of synchronizing a left image stream and a right image stream according to an exemplary embodiment of the present invention.

### BEST MODE FOR CARRYING OUT THE INVENTION

Hereinafter, exemplary embodiments of the present invention will be described in detail with reference to the accompanying drawings.

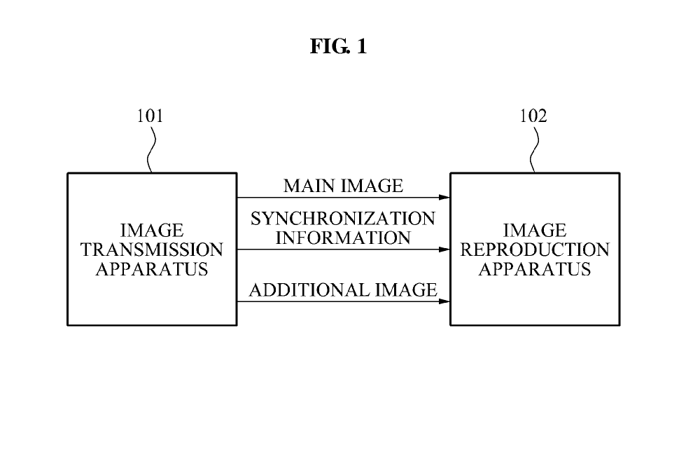

FIG. 1 illustrates an image transmission apparatus and an image reproduction apparatus according to an exemplary embodiment of the present invention.

Referring to FIG. 1, the image transmission apparatus 101 may transmit a main image and an additional image for a three-dimensional (3D) image to the image reproduction apparatus 102. For example, the main image is for a high-definition (HD) two-dimensional (2D) stationary broadcast and may be transmitted to the image reproduction apparatus 102 in accordance with Moving Picture Experts Group-2 (MPEG-2). The additional image is for a 2D mobile broadcast and may be transmitted to the image reproduction apparatus 102 in accordance with Advance Video Coding (AVC). The image reproduction apparatus 102 may receive the main image and the additional image in a stream form to provide a 3D image to viewers via 3D rendering.

The main image and the additional image are transmitted via a single 6 megahertz (MHz) channel to enable a 3DTV to broadcast all of an HD 2DTV, a mobile 2DTV and an HD 3DTV, thus optimizing frequency efficiency. Here, the main image may correspond to a left image for the 3D image, and the additional image may correspond to a right image for the 3D image. Alternatively, the main image may correspond to the right image, and the additional image may correspond to the left image. The following description will be made on the assumption that the main image is transmitted in a left image stream, and the additional image is transmitted in a right image stream.

The main image as the left image and the additional image as the right image, taken at the same time, may be provided simultaneously to viewers to realize the 3D image. However, for a 3DTV broadcast service, the main image and the additional image may involve different process times due to different encoding, multiplexing, modulation, transmission, demodulation, demultiplexing, or decoding processes. Thus, the image transmission apparatus 101 may convey, through a broadcast stream, synchronization information to identify the left image and the right image that the image reproduction apparatus 102 presents simultaneously so as to synchronize the main image as the left image and the additional image as the right image.

Here, the image transmission apparatus 101 may transmit the synchronization information to the image reproduction apparatus 102 so that the image reproduction apparatus 102 synchronizes the main image and the additional image that have different timing models. Here, the synchronization information is an offset (an absolute value and a sign of a difference between the main image and the additional image) that is a difference between timestamps of the main image and the additional image to be presented simultaneously at an arbitrary point of time for the 3D image. Alternatively, the synchronization information may be pair information about the timestamps of the main image and the additional image (also, referred to as “timestamp pair information”). Subsequently, the image reproduction apparatus 102 may determine a time to present the main image and the additional image based on the synchronization information.

The present invention is based on the assumption that the main image and the additional image which have different timing models needed for the 3DTV image do not simultaneously arrive in a 3DTV device. That is, the main image and the additional image are transmitted via different broadcast networks and thus may not simultaneously arrive in the image reproduction apparatus 102. Thus, before synchronization of the main image and the additional image, the image reproduction apparatus 102 may need to store an image stream first received in a buffer and wait for a not-yet received image stream.

Accordingly, the present invention suggests how to manage buffers for the main image and the additional image. In detail, the present invention suggests a method of determining sizes of the buffers based on a difference in reception time (“reception time difference”) between the main image and the additional image. Meanwhile, the present invention may determine when to output the main image and the additional image from the buffers to decoders, respectively. In addition, the present invention proposes a process of matching the main image and the additional image. In particular, the present invention may provide a method of storing a stream of the left image and a stream of the right image in the buffers before decoding to minimize a delay time in synchronization of the image streams, thereby reducing inefficiency of buffer management due to delays in receiving the image streams.

In the present invention, for instance, the main image may have a timing model based on an MPEG-2 system, while the additional image may have a real-time transport protocol (RTP)-based timing model. However, the present invention is not limited to the preceding example but may adopt any timing model as long as the main image and the additional image have different timing models.

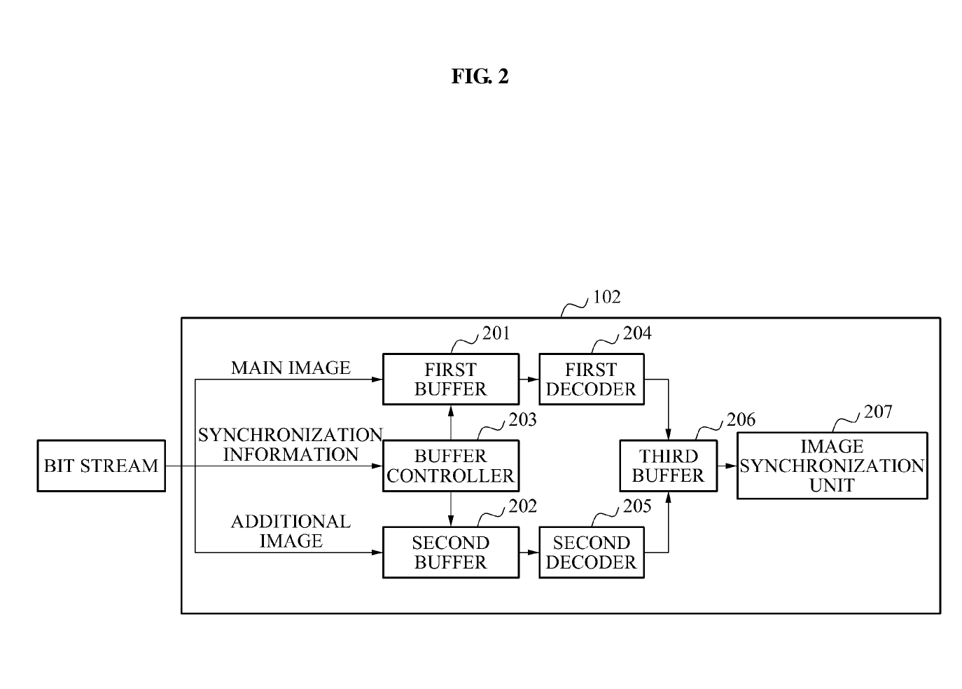

FIG. 2 illustrates a configuration of the image reproduction apparatus according to an exemplary embodiment of the present invention.

Referring to FIG. 2, the image reproduction apparatus 102 may include a first buffer 201, a second buffer 202, a buffer controller 203, a first decoder 204, a second decoder 205, a third buffer 206 and an image synchronization unit 207.

The first buffer 201 may store a stream of a left image (also, referred to as a “left image stream”) as a main image transmitted via a first broadcast network. The second buffer 202 may store a stream of a right image (also, referred to as a “right image stream”) as an additional image transmitted via a second broadcast network. The first buffer 201 may temporarily store the left image stream before decoding the left image stream, and the second buffer 202 may temporarily store the right image stream before decoding the right image stream.

<Determination of Buffer Size>

The buffer controller 203 may determine buffer sizes of the first buffer 201 and the second buffer 202. Here, the buffer controller 203 may determine the buffer sizes of the first buffer 201 and the second buffer 202 using a reception time difference between the left image stream and the right image stream. Here, the reception time difference may occur as the left image stream and the right image stream transmitted from the image transmission apparatus 101 do not simultaneously arrive in the image reproduction apparatus 102.

The buffer controller 203 may acquire information about synchronization (“synchronization information”) of the left image stream and the right image stream. Here, the synchronization information may be extracted by demultiplexing a bit stream. For instance, the synchronization information may include information about a timestamp pair including a first timestamp of the left image stream and a second timestamp of the right image stream to be simultaneously presented at an arbitrary point of time. Alternatively, the synchronization information may include information about an offset between the first timestamp of the left image stream and the second timestamp of the right image stream.

For example, when the left image stream is transmitted according to an Advanced Television Systems Committee (ATSC) standard for a stationary broadcast and the right image stream is transmitted according to a mobile digital television (MDTV) standard for a mobile broadcast, the first timestamp may be a presentation timestamp (PTS) and the second timestamp may be a real-time protocol (RTP) timestamp. Here, the offset information may include an absolute value and a sign of a difference between the first timestamp and the second timestamp. The synchronization information may be signaled through at least one of the left image stream and the right image stream.

The buffer controller 203 may extract the first timestamp of the left image stream and the second timestamp of the right image stream. For instance, the first timestamp may be a decoding timestamp (DTS) of the left image stream and the second timestamp may be a DTS of the right image stream. In the case of an RTP stream having no DTS, the presentation timestamps, the PTS and the RTP timestamp, may be extracted. Also, when there is no timestamp, a frame identification number or Society of Motion Picture and Television Engineers (SMTPE) time code may be used.

The timestamps may be extracted from access units (AUs) received at the same time, which are stored last in the first buffer 201 and the second buffer 202. Alternatively, the first timestamp and the second timestamp may be extracted respectively from a left image stream and a right image stream extracted at similar time points via demultiplexing of a bit stream.

For instance, the buffer controller 203 may extract a first timestamp of a left image frame stored last in the first buffer 201. The buffer controller 203 may extract a second timestamp of a right image frame stored last in the second buffer 202.

Here, the buffer controller 203 may extract a PTS of a first frame among a group of pictures (GOP) of the left image stream stored last in the first buffer 201. Alternatively, the buffer controller 203 may extract a PTS of a last frame or a main frame of the GOP of the left image stream stored last in the first buffer 201.

The buffer controller 203 may extract an RTP timestamp of a first frame among a GOP of the right image stream stored last in the second buffer 202. Alternatively, the buffer controller 203 may extract an RTP timestamp of a last frame or a main frame of the GOP of the right image stream stored last in the second buffer 202. Meanwhile, the buffer controller 203 may extract a timestamp of an AU stored last, instead of a GOP, to quickly calculate the buffer sizes.

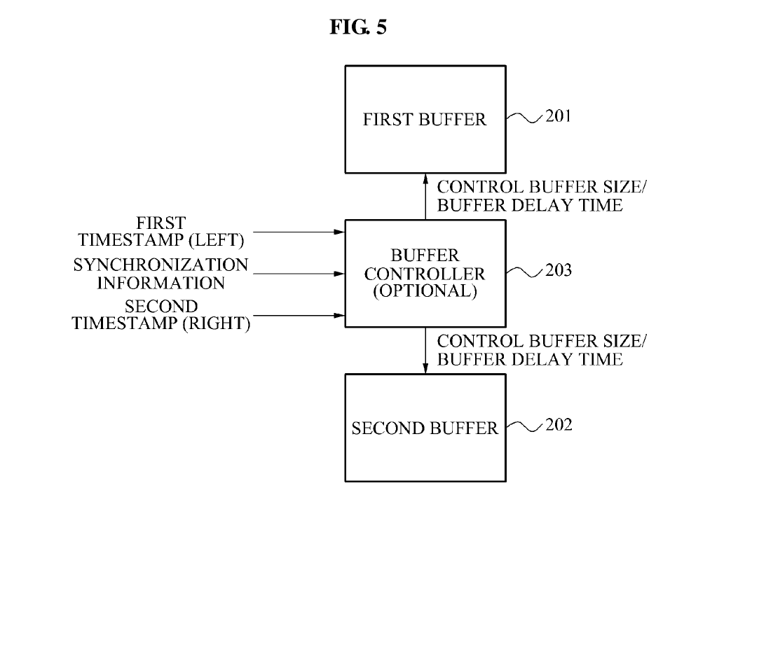

A process of extracting the synchronization information, the first timestamp and the second timestamp will be described in detail with reference to FIG. 5.

The buffer controller 203 may calculate the reception time difference between the left image stream and the right image stream. For example, the buffer controller 203 may calculate the reception time difference using the synchronization information, a timestamp of the left image stream and a timestamp of the right image stream.

When the left image stream and the right image stream use the same reference clock, the buffer controller 203 may calculate the reception time difference using a timestamp difference between the first timestamp and the second timestamp. When the left image stream and the right image stream use different reference clocks, the buffer controller 203 may convert one of the first timestamp and the second timestamp using the synchronization information to calculate a reception time difference between the first timestamp and the second timestamp. When a random offset is applied to the first timestamp or the second timestamp like an RTP timestamp, the buffer controller 203 may convert one of the first timestamp and the second timestamp using the synchronization information to calculate the reception time difference between the first timestamp and the second timestamp. In detail, the buffer controller 203 may convert the first timestamp into the same form as the second timestamp or convert the second timestamp into the same form as the first timestamp using the synchronization information.

More generally, the buffer controller 203 may convert presentation time information about one of the image streams, for example, a timestamp, a frame identification number and an SMTPE time code, into presentation time information about the other of the image streams using the synchronization information, thereby calculating the reception time difference.

When the presentation timestamps, that is, the PTS and the RTP timestamp, are used instead of the DTSs in calculating the difference in reception time between the left image stream and the right image stream, a decoding sequence and a buffer output sequence may not correspond with each other. In this case, the buffer controller 203 may control the buffer sizes and the output times considering a number of successive B frames in the image streams. For example, when there are three successive B frames in the image streams, a difference between the reception time difference calculated using the presentation timestamps and a difference between times to actually input the left image stream and the right image stream respectively to the first buffer 201 and the second buffer 202 may be up to 4. In this case, the buffer controller 203 may add a 4 frame transmission time to the calculated reception time difference to deal with an error. Alternatively, the buffer controller 203 may control the buffer sizes and the buffer output times in view of a GOP size. For example, when an output unit of the buffers is a GOP, the buffer controller 203 may add a frame transmission time corresponding to a number of frames forming a GOP to the calculated reception time difference to deal with an error.

The buffer controller 203 may determine the buffer sizes using the reception time difference between the left image stream and the right image stream. For example, the buffer controller 203 may calculate a number of delayed frames between the left image stream and the right image stream using a number of AUs stored in the buffers, the reception time difference and frame rates of the image streams, and determine the buffer sizes dynamically set up based on the calculated number of frames.

The buffer controller 203 may determine the buffer sizes using a constant bit rate of the left image stream or the right image stream and the reception time difference. Alternatively, the buffer controller 203 may determine the buffer sizes using a data rate of the left image stream or the right image stream and the reception time difference.

The process of controlling the buffer sizes mentioned above will be described in detail with reference to FIG. 5.

<Determination of Buffer Delay Time>

The buffer controller 203 may calculate the reception time difference between the left image stream and the right image stream using the first timestamp of the left image stream, the second timestamp of the right image stream and the synchronization information. A process of calculating the reception time difference is the same as described above.

The buffer controller 203 may determine a buffer delay time using the reception time difference. Here, when the right image stream is received before the left image stream, the buffer controller 203 may increase a buffer delay time of the right image stream by the reception time difference. That is, since the right image stream is received before the left image stream, the buffer controller 203 may delay an output time of the second buffer 202 for the reception time difference as compared with an output time of the first buffer 201.

On the contrary, when the left image stream is received before the right image stream, the buffer controller 203 may increase a buffer delay time of the left image stream by the reception time difference. That is, since the left image stream is received before the right image stream, the buffer controller 203 may delay the output time of the first buffer 201 for the reception time difference as compared with the output time of the second buffer 202.

<Correction of Reference Clock and Timestamp>

As described above, in the 3DTV service, the image reproduction apparatus 102 may receive the left image stream and the right image stream at different time points. However, it may be difficult to predict a reception delay time between the left image stream and the right image stream at a time point to transmit the left image stream and the right image stream to the image reproduction apparatus 102. In particular, when the left image stream and the right image stream independently provide unique services, for example, a terrestrial 2D broadcast service, a mobile 2D broadcast service, an IPTV broadcast service and a video on demand (VOD) service, a reference clock of the image streams, for example, a program clock reference (PCR), and a timestamp of an AU, for example, a PTS and a DTS, may not consider a reception delay time in the 3D service so as to secure compatibility with an existing 2D service.

In particular, when time information, such as a reference clock and a timestamp, is used not only for a 2D service but also for a 3D service, a reception delay time until another image stream operates is considered for operation of the 3D service.

According to the present invention, even though there is a reception time difference between the left image stream and the right image stream, a reference clocks or timestamp is corrected, enabling the first decoder 204 to process the left image stream and the second decoder 205 to process the right image stream to normally operate even in the presence of the reception time difference.

To correct a reference clock, the buffer controller 203 may calculate a reception time difference between an AU of the left image stream and an AU of the right image stream. The buffer controller 203 may correct a reference clock signaled to one of the left image stream and the right image stream that is received before the other thereof using the reception time difference. Here, the buffer controller 203 may correct the reference clock using a result of applying the reception time difference to a clock rate of the reference clock.

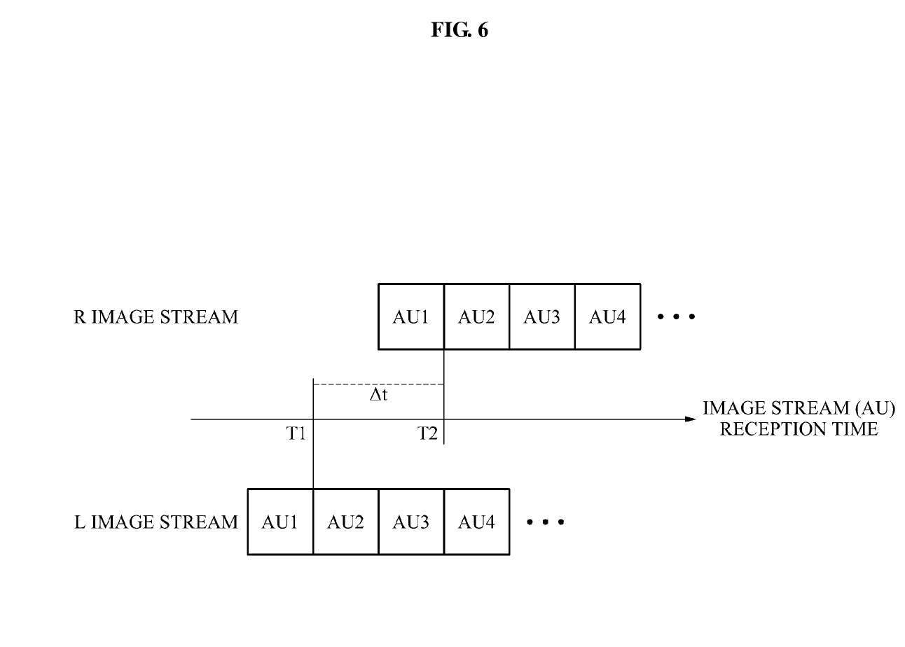

To correct a timestamp, the buffer controller 203 may calculate the reception time difference between the AU of the left image stream and the AU of the right image stream. The buffer controller 203 may correct the first timestamp of the left image stream and the second timestamp of the right image stamp using the reception time difference. Here, the buffer controller 203 may correct the first timestamp of the left image stream and the second timestamp of the right image stamp using a result of applying the reception time difference to the clock rate of the reference clock. The processes of correcting the reference clock and the timestamps will be described in detail with reference to FIG. 6.

The first decoder 204 may decode the left image stream transmitted from the first buffer 201 and store the left image stream in the third buffer 206. The second decoder 205 may decode the right image stream transmitted from the second buffer 202 and store the right image stream in the third buffer 206.

The image synchronization unit 207 may synchronize the left image stream and the right image stream stored in the third buffer 206 and transmit to a 3D renderer. For example, the image synchronization unit 207 may acquire the synchronization information extracted by demultiplexing a bit stream. The image synchronization unit 207 may acquire the first timestamp of the left image stream and the second timestamp of the right image stream stored in the third buffer 206.

The image synchronization unit 207 may convert at least one of the first timestamp and the second timestamp to correspond to the reference clock using the synchronization information. For example, the image synchronization unit 207 may convert the RTP timestamp of the right image stream into the same form as the timestamp of the left image stream to correspond to the PCR as the reference clock. The left image stream may have a timestamp corresponding to the PCR, that is, the PTS. The image synchronization unit 207 may match the left image stream and the right image stream extracted from the third buffer 206 based on the PCR through the timestamp and transmit to the 3D renderer that generates a 3D image.

That is, although the left image stream and the right image stream have different timing models, the image synchronization unit 207 may convert one of the first timestamp of the right image stream and the second timestamp of the right image stream into a timestamp in the same form as the other according to the reference clock. The image synchronization unit 207 may match the first timestamp and the second timestamp to match the left image stream and the right image stream.

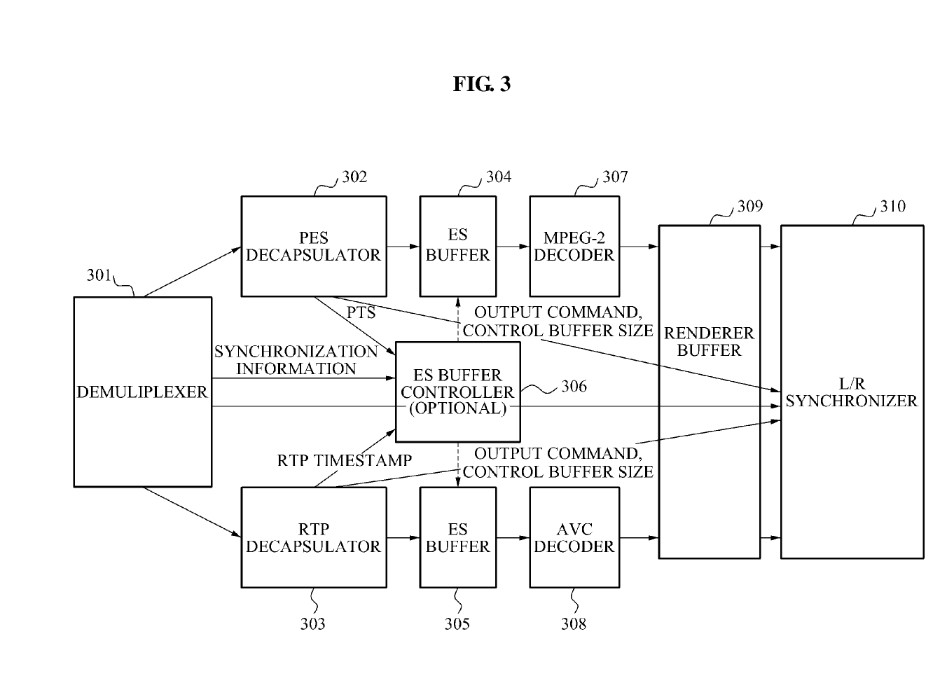

FIG. 3 illustrates an example of the image reproduction apparatus according to an exemplary embodiment of the present invention.

Referring to FIG. 3, the image reproduction apparatus may include a demultiplexer 301, a packetized elementary stream (PES) decapsulator 302, an RTP decapsulator 303, an ES buffer 304, an ES buffer 305, an ES buffer controller 306, an MPEG-2 decoder 307, an AVC decoder 308, a renderer buffer 309, and an L/R synchronizer 310. Here, the ES buffer 304 corresponds to the first buffer 201, the ES buffer 305 corresponds to the second buffer 202, and the ES buffer controller 306 corresponds to the buffer controller 203. The MPEG-2 decoder 307 corresponds to the first decoder 204, and the AVC decoder 308 corresponds to the second decoder 205. Further, the renderer buffer 309 corresponds to the third buffer 206, and the L/R synchronizer 310 corresponds to the image synchronization unit 207.

The demultiplexer 301 may demultiplex a bit stream to extract a left image stream, a right image stream and synchronization information. Here, the left image stream corresponds to a main image of a 3D image and is used for a high-quality HD 2D stationary broadcast. The left image stream is processed in accordance with the MPEG-2 system and transmitted through an ATSC main stream. The right image stream corresponds to an additional image of the 3D image and is used for a 2D mobile broadcast. The right image stream is processed in accordance with AVC and transmitted through an ATSC Mobile Handheld (M/H) stream. Here, the extracted synchronization information may be transmitted to the ES buffer controller 306.

The PES decapsulator 302 may decapsulate a PES of the left image stream. A PTS as a first timestamp of the left image stream extracted during this process may be transmitted to the ES buffer controller 306 and the L/R synchronizer 310. Meanwhile, the RTP decapsulator 303 may decapsulate an RTP packet of the capsulated right image stream. An RTP timestamp as a second timestamp of the right image stream extracted during this process may be transmitted to the ES buffer controller 306 and the L/R synchronizer 310.

The left image stream extracted by the PES decapsulator 302 may be stored in the ES buffer 304, while the right image stream extracted by the RTP decapsulator 303 may be stored in the ES buffer 305. Here, the ES buffer 304 and the ES buffer 305 may temporarily store the left image stream and the right image stream before decoding in a situation of delays in receiving the left image stream and the right image stream. The ES buffer 304 and the ES buffer 305 may be set up as a TS buffer 304 and a TS buffer 305.

The ES buffer controller 306 may control and manage the ES buffer 304 and the ES buffer 305.

(1) For example, the ES buffer controller 306 may determine buffer sizes of the ES buffer 304 and the ES buffer 305. Here, the ES buffer controller 306 may determine the buffer sizes of the ES buffer 304 and the ES buffer 305 using a reception time difference between the left image stream and the right image stream. Here, the reception time difference may occur as the left image stream and the right image stream transmitted from the image transmission apparatus 101 do not simultaneously arrive in the image reproduction apparatus 102.

The ES buffer controller 306 may acquire information about synchronization of the left image stream and the right image stream. The ES buffer controller 306 may extract a first timestamp of the left image stream and a second timestamp of the right image stream. The ES buffer controller 306 may calculate the reception time difference between the left image stream and the right image stream using the first timestamp, the second timestamp and the synchronization information and determine the buffer sizes using the reception time difference.

(2) Further, the ES buffer controller 306 may determine a buffer delay time using the reception time difference. Here, when the right image stream is received before the left image stream, the ES buffer controller 306 may increase a buffer delay time of the right image stream by the reception time difference. That is, since the right image stream is received before the left image stream, the ES buffer controller 306 may delay an output time of the ES buffer 305 for the reception time difference as compared with an output time of the ES buffer 304.

On the contrary, when the left image stream is received before the right image stream, the ES buffer controller 306 may increase a buffer delay time of the left image stream by the reception time difference. That is, since the left image stream is received before the right image stream, the ES buffer controller 306 may delay the output time of the ES buffer 304 for the reception time difference as compared with the output time of the ES buffer 305.

Ultimately, the ES buffer controller 306 may determine an output time point of the ES buffer 304 to transmit the left image stream to the MPEG-2 decoder 307 and an output time point of the ES buffer 305 to transmit the right image stream to the AVC decoder 308.

(3) Even though the reception time difference between the left image stream and the right image stream occurs, the ES buffer controller 306 may correct a reference clock or timestamp, enabling the MPEG-2 decoder 307 to process the left image stream and the AVC decoder 308 to process the right image stream to normally operate even in the presence of the reception time difference.

To correct a reference clock, the ES buffer controller 306 may calculate a reception time difference between an AU of the left image stream and an AU of the right image stream. The ES buffer controller 306 may correct a reference clock signaled to one of the left image stream and the right image stream that is received before the other thereof using the reception time difference. Here, the ES buffer controller 306 may correct the reference clock using a result of applying the reception time difference to a clock rate of the reference clock.

To correct a timestamp, the ES buffer controller 306 may calculate the reception time difference between the AU of the left image stream and the AU of the right image stream. The ES buffer controller 306 may correct the first timestamp of the left image stream and the second timestamp of the right image stamp using the reception time difference. Here, the buffer controller 203 may correct the first timestamp of the left image stream and the second timestamp of the right image stamp using a result of applying the reception time difference to the clock rate of the reference clock.

The MPEG-2 decoder 307 may decode the left image stream transmitted from the ES buffer 304 and store the left image stream in the renderer buffer 309. The AVC decoder 308 may decode the right image stream transmitted from the ES buffer 305 and store the left image stream in the renderer buffer 309.

The L/R synchronizer 310 may synchronize the left image stream and the right image stream stored in the renderer buffer 309. For example, the L/R synchronizer 310 may acquire the synchronization information from a bit stream. The L/R synchronizer 310 may acquire the timestamps of the left image stream and the right image stream stored in the renderer buffer 309. The L/R synchronizer 310 may convert the timestamp of the right image stream based on the timestamp of the left image stream using the synchronization information. For example, the L/R synchronizer 310 may convert the RTP timestamp of the right image stream into a timestamp based on a PCR. The left image stream may have a PTS corresponding to the PCR. The L/R synchronizer 310 may match the left image stream and the right image stream extracted from the renderer buffer 309 based on the PCR and transmit to the 3D renderer that generates a 3D image.

That is, although the left image stream and the right image stream have different timing models, the L/R synchronizer 310 may convert the timestamp of the right image stream according to a reference clock of the timestamp of the left image stream and synchronize the timestamp of the left image stream and the converted timestamp of the right image stream according to the reference clock to match the left image stream and the right image stream. Although the foregoing embodiment illustrates a process of converting the timestamp of the right image stream according to the reference clock relevant to the timestamp of the left image stream, a process of converting the timestamp of the left image stream according to a reference clock relevant to the timestamp of the right image stream may be also included within the scope of the present invention.

Ultimately, according to the present invention, an output time to transmit the left image stream corresponding to the left image of the 3D image from the ES buffer 304 to the MPEG-2 decoder 307 and an output time to transmit the right image stream corresponding to the right image of the 3D image from the ES buffer 305 to the AVC decoder 308 may be determined.

Also, the present invention may determine the buffer sizes of the ES buffer 304 and the ES buffer 305 using the reception time difference between the left image stream and the right image stream.

Further, the present invention may correct the reference clock and the timestamps using the reception time difference between the left image stream and the right image stream.

In addition, the present invention may match the left image stream and the right image stream transmitted to the 3D renderer which generates a 3D image.

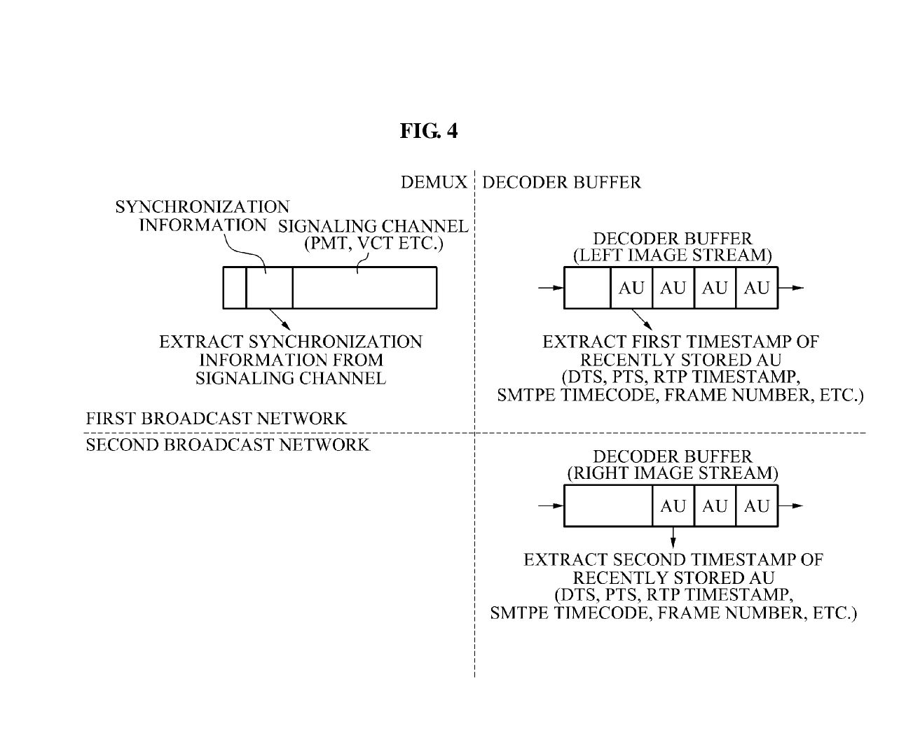

FIG. 4 illustrates a process of extracting synchronization information, a first timestamp and a second timestamp according to an exemplary embodiment of the present invention.

Referring to FIG. 4, synchronization information may be signaled to a bit stream and transmitted via a first broadcast network. As necessary, the synchronization information may be transmitted via a second broadcast network. The image transmission apparatus 101 may generate, as the synchronization information, pair information about timestamps, for example, a PTS and an RTP timestamp, of a left image stream and a right image stream to be presented simultaneously at an arbitrary point of time in a program so as to conduct synchronization of the left image stream and the right image stream. Alternatively, the image transmission apparatus 101 may generate, as the synchronization information, information about an offset between the timestamps of the left image stream and the right image stream (an absolute value and a sign of a difference between the timestamps). The image reproduction apparatus 102 may extract the synchronization information from a signaling channel of the bit stream transmitted through the broadcast network.

The buffer controller 203 may acquire information about synchronization of the left image stream and the right image stream. Here, the synchronization information may be extracted by demultiplexing the bit stream. For instance, the synchronization information may include information about a timestamp pair including a first timestamp of the left image stream and a second timestamp of the right image stream to be presented simultaneously at an arbitrary point of time. Alternatively, the synchronization information may include information about an offset between the first time stamp of the left image stream and the second time stamp of the right image stream.

For example, when the left image stream is transmitted according to an ATSC main broadcast standard for a stationary broadcast and the right image stream is transmitted according to an MDTV broadcast standard for a mobile broadcast, the first timestamp may be a PTS and the second timestamp may be an RTP timestamp. Here, the offset information may include an absolute value and a sign of a difference between the first timestamp and the second timestamp. The synchronization information may be signaled through at least one of the left image stream and the right image stream.

The buffer controller 203 may extract the first timestamp of the left image stream and the second timestamp of the right image stream. For instance, the first timestamp may be a DTS of the left image stream and the second timestamp may be a DTS of the right image stream. In the case of an RTP stream having no DTS, the presentation timestamps, the PTS and the RTP timestamp, may be extracted. Also, when there is no timestamp, a frame identification number or SMTPE time code may be used.

The timestamps may be extracted from AUs received at the same time, which are stored last in the first buffer 201 and the second buffer 202. Alternatively, the first timestamp and the second timestamp may be extracted respectively from a left image stream and a right image stream extracted at similar time points via demultiplexing of the bit stream.

For instance, the buffer controller 203 may extract a first timestamp of a left image frame stored last in the first buffer 201. The buffer controller 203 may extract a second timestamp of a right image frame stored last in the second buffer 202. Here, the buffer controller 203 may extract a PTS of a first frame among a GOP of the left image stream stored last in the first buffer 201. Alternatively, the buffer controller 203 may extract a PTS of a last frame or a main frame of the GOP of the left image stream stored last in the first buffer 201.

The buffer controller 203 may extract an RTP timestamp of a first frame among a GOP of the right image stream stored last in the second buffer 202. Alternatively, the buffer controller 203 may extract an RTP timestamp of a last frame or a main frame of the GOP of the right image stream stored last in the second buffer 202. Meanwhile, the buffer controller 203 may extract a timestamp of an AU stored last, instead of a GOP, to quickly calculate the buffer sizes.

Meanwhile, the buffer controller 203 may extract the first timestamp from an AU of a left image stream stored last in a decoder buffer. The image reproduction apparatus 102 may extract the second timestamp from an AU of a right image stream stored last in the decoder buffer. In FIG. 4, an AU disposed toward a left side denotes being stored lately and an AU disposed toward a right side denotes being stored earlier. Here, reference AUs are an AU of the left image stream from which the first timestamp is extracted and an AU of the right image stream from which the second timestamp is extracted, which are received at the same time. Here, the decoder buffer may be represented by an ES buffer or TS buffer.

Here, the first timestamp and the second timestamp may be any one of a DTS, a PTS, an RTP timestamp, an SMTPE time code, and a frame number. Here, the timestamps extracted by the buffer controller 203 may be a DTS. However, when there is no DTS, the presentation timestamps, the PTS and the RTP timestamp, may be extracted. Further, when there is no timestamp, a frame identification number and an SMTPE time code may be extracted.

FIG. 5 illustrates a process of controlling a buffer size according to an exemplary embodiment of the present invention.

The buffer controller 203 may control buffer sizes of the first buffer 201 and the second buffer 202 using synchronization information, a first timestamp of a left image stream and a second timestamp of a right image stream.

The buffer controller 203 may determine the buffer sizes of the first buffer 201 and the second buffer 202. Here, the buffer controller 203 may determine the buffer sizes of the first buffer 201 and the second buffer 202 using a reception time difference between the left image stream and the right image stream. Here, the reception time difference may occur as the left image stream and the right image stream transmitted from the image transmission apparatus 101 do not simultaneously arrive in the image reproduction apparatus 102.

The buffer controller 203 may determine buffer delay times of the first buffer 201 and the second buffer 202 using the synchronization information, the first timestamp of the left image stream and the second timestamp of the right image stream.

The buffer controller 203 may determine the buffer delay times of the first buffer 201 and the second buffer 202. Here, the buffer controller 203 may determine the buffer delay times of the first buffer 201 and the second buffer 202 using the reception time difference between the left image stream and the right image stream. Here, the reception time difference may occur as the left image stream and the right image stream transmitted from the image transmission apparatus 101 do not simultaneously arrive in the image reproduction apparatus 102.

The buffer controller 203 may calculate the reception time difference between the left image stream and the right image stream. For example, the buffer controller 203 may calculate the reception time difference using the synchronization information, the first timestamp of the left image stream and the second timestamp of the right image stream. The process of extracting the synchronization information, the first timestamp and the second timestamp has been described above with reference to FIG. 4.

When the left image stream and the right image stream use the same reference clock, the buffer controller 203 may calculate the reception time difference using a timestamp difference between the first timestamp and the second timestamp.

When the left image stream and the right image stream use different reference clocks, the buffer controller 203 may convert one of the first timestamp and the second timestamp using the synchronization information to calculate a reception time difference between the first timestamp and the second timestamp. When a random offset is applied to the first timestamp or the second timestamp like an RTP timestamp, the buffer controller 203 may convert one of the first timestamp and the second timestamp using the synchronization information to calculate the reception time difference between the first timestamp and the second timestamp. In detail, the buffer controller 203 may convert the first timestamp into the same form as the second timestamp or convert the second timestamp into the same form as the first timestamp using the synchronization information.

When the synchronization information is information about a timestamp pair, the following conversion process may be carried out.

The timestamp pair as a reference of synchronization includes timestamps of the AU of the left image and the AU of the right image, which are simultaneously presented at an arbitrary point of time. In the present embodiment using a PTS based left image stream and a PTS based right image stream, the timestamp pair includes [PTS_Sync, RTV_Sync_V]. Here, the PTS Sync refers to the PTS of the synchronization reference time point, and the RTV_Sync_V refers to an RTP timestamp of the same reference time point.

For instance, the buffer controller 203 calculates a timestamp difference (RTD_V) between an RTP_Timestamp (RTP_Vₙ) of an AU M-AUₙ included in a stream of an additional image and an RTP_Timestamp (RTP_Sync_V) of an AU as the synchronization information. Here, the M-AUₙ refers to the AU of the right image of which the RTP timestamp is to be converted into the PTS form.

Subsequently, the buffer controller 203 adds the calculated timestamp difference (RTD_V) and a PTS (PTS_Sync) of an AU as a synchronization reference and subjects the addition result to a 2̂32 modulo operation. Through this process, the buffer controller 203 may convert the RTP timestamp of each AU included in the stream of the additional image into a timestamp (PTS of M-AUₙ) in a form of which an presentation point is calculated based on a PCR.

When RTP_Vₙ is less than RTP_Sync_V, the buffer controller 203 uses (RTP_Vₙ−RTP_Sync_V)+2̂32 in calculating RTD_V to prevent a rollover of the timestamp. When RTP_Vₙ is RTP_Sync_V or greater, the buffer controller 203 uses (RTP_Vₙ−RTP_Sync_V) % 2̂32 for calculating RTD_V.

When the synchronization information is offset information about a timestamp, the following conversion process may be carried out.

When the left image stream and the right image stream for a 3DTV broadcast service have the same frame rate and the timestamps have the same clock rate, an offset between the timestamps of the left image stream and the right image stream may be used as the synchronization information. For example, in a stationary and mobile hybrid 3DTV system, the left image stream and the right image stream have the same frame rate and an PTS of an MPEG-2 system and an RTP timestamp of an MDTV system have the same clock rate. Accordingly, a timestamp offset mode may be used, in which timestamps offsets corresponding to AUs of the left and right images to be presented at the same point of time, chosen arbitrarily, for a 3DTV service are used as synchronization information.

When an offset sign bit is 0, the buffer controller 203 may subject a result of adding RTP_Timestamp (RTP_Vₙ) of the AU (M-AUₙ) of the right image stream and a timestamp offset of the AU as the synchronization reference to a 2̂32 modulo operation. Here, the M-AUₙ refers to the AU of the right image of which the RTP timestamp is to be converted into the PTS form. Then, the buffer controller 203 may calculate a timestamp (PTS of M-AUₙ) of each AU included in the right image stream in a form of which an presentation point is calculated based on the PCR. Here, when the offset sign bit is 0, the timestamp offset is positive. When the offset sign bit is 1, the timestamp offset is negative.

When the offset sign bit is 1 and RTP_Vₙ is the timestamp offset or greater, the buffer controller 203 uses RTP_Vₙ−timestamp_offset in calculating the PTS of the AU included in the right image stream. When the offset sign bit is 1 and RTP_Vₙ is less than the timestamp offset, the buffer controller 203 uses RTP_Vₙ−timestamp_offset+2̂32 in calculating the PTS of the AU included in the right image stream.

The buffer controller 203 converts presentation time information about one of the image streams, for example, a timestamp, a frame identification number and an SMTPE time code, into presentation time information about the other of the image streams using the synchronization information, thereby calculating the reception time difference.

A process of calculating the reception time difference is illustrated as follows. Method 1 is used when the synchronization information is the timestamp pair, while method 2 is used when the synchronization information is the offset information.

<Method 1>

(i) Synchronization information: Pair of timestamp of left image stream and timestamp of right image stream (left: 100, right: 200)

(ii) Timestamps of AU of left image stream and AU of right image stream stored last in first buffer 201 and second buffer 202 (left: 500, right: 800)

(iii) Result of conversion of timestamp of right image stream into timestamp of left image stream: 800−(200−100)=700

(iv) Reception time difference between timestamp of left image stream and converted timestamp of right image stream: 500 (left)−700 (right)=−200

(v) If clock rate of timestamp of left image stream is 100 Hz, −200/100=−2, and thus left image stream arrives 2 seconds before right image stream

<Method 2>

(i) Synchronization information: Timestamp offset between left image stream and right image stream: −100

(ii) Timestamps of AU of left image stream and AU of right image stream stored last in first buffer 201 and second buffer 202 (left: 500, right: 800)

(iii) Result of conversion of timestamp of right image stream into timestamp of left image stream: 800+(−100)=700

(iv) Reception time difference between timestamp of left image stream and converted timestamp of right image stream: 500 (left)−700 (right)=−200

(v) If clock rate of timestamp of left image stream is 100 Hz, −200/100=−2, and thus left image stream arrives 2 seconds before right image stream

When the presentation timestamps, that is, the PTS and the RTP timestamp, are used instead of the DTSs in calculating the reception time difference between the left image stream and the right image stream, a decoding sequence and a buffer output sequence may not correspond with each other. In this case, the buffer controller 203 may control the buffer sizes and the output times considering a number of successive B frames in the image streams. For example, when there are three successive B frames in the image streams, a difference between the reception time difference calculated using the presentation timestamps and a difference between times to actually input the left image stream and the right image stream respectively to the first buffer 201 and the second buffer 202 may be up to 4. In this case, the buffer controller 203 may add a 4 frame transmission time to the calculated reception time difference to deal with an error.

Alternatively, the buffer controller 203 may control the buffer sizes and the output times in view of a GOP size. For example, when an output unit of the buffers is a GOP, the buffer controller 203 may add a frame transmission time corresponding to a number of frames forming a GOP to the calculated reception time difference to deal with an error.

The buffer controller 203 may determine the buffer sizes using the reception time difference between the left image stream and the right image stream. For example, the buffer controller 203 may calculate a number of delayed frames between the left image stream and the right image stream using a number of AUs stored in the buffers, the reception time difference and frame rates of the image streams, and determine the buffer sizes dynamically set up based on the calculated number of frames.

The buffer controller 203 may determine the buffer sizes using a constant bit rate of the left image stream or the right image stream and the reception time difference. Alternatively, the buffer controller 203 may determine the buffer sizes using a data rate of the left image stream or the right image stream and the reception time difference.

Here, the reception time difference is represented by Δt. Hereinafter, a process of calculating the buffer sizes using the reception time difference is described.

<Method 1> In case where a number of AUs of a left image stream stored in the first buffer 201 and a number of AUs of a right image stream stored in the second buffer 202 are identified

Here, when the frame rates of the image streams are fr, a number of delayed frames between the left image stream and the right image stream is Δt*fr. That is, the buffer controller 203 may store and maintain Δt*fr frames of one image stream received before the other image stream. In other words, a buffer to store the one image stream received first may have a buffer size Δt*fr larger than that of a buffer to store the other image stream received later. The buffer sizes may change dynamically.

<Method 2> In case where the first buffer 201 and the second buffer 202 are ES buffers and use a constant bit rate

Here, when the constant bit rate is br, the buffer controller 203 may control the buffer for the image stream received first to maintain a maximum buffer size of Δt*br+VBV buffer.

<Method 3> In case where the first buffer 201 and the second buffer 202 are TS buffers and use a variable bit rate

Here, when the variable bit rate is tbr, the buffer controller 203 may control the buffer for the image stream received first to maintain a maximum buffer size of Δt*tbr+VBV buffer.

For example, the buffer controller 203 may convert the RTP timestamp as the second timestamp into a timestamp based on the PCR. The buffer controller 203 may extract a difference between the RTP timestamp converted based on the PCR and PTS %2̂32 and determine the buffer sizes using the extracted difference. For example, the buffer controller 203 may calculate the buffer sizes according to Equation 1.

Buffersize=(timestamp_difference/90,000)*19.39 (Mb)+VBV buffer size [Equation 1]

Here, timestamp_difference denotes a reception time difference based on a timestamp difference between the left image stream and the right image stream. When the RTP timestamp converted based on the PCR is greater than PTS %2̂32, the buffer size of the second buffer 202 is determined by Equation 1 and the buffer size of the first buffer 201 is a VBV buffer size. For example, when the RTP timestamp converted based on the PCR is greater by 180,000 than PTS %2̂32, the buffer size of the second buffer 202 may be determined by Buffer_size=(180,000/90,000)*19.39 Mbps+VBV buffer size=38.78 Mb+VBV buffer size.

Similarly, the buffer controller 203 may determine the output times of the first buffer 201 and the second buffer 202 using the reception time difference. Here, the output times may correspond to the buffer delay times. Here, the method of determining the output times may be also employed when a buffer with a fixed size is used, unlike the method of dynamically determining the buffer sizes.

Here, the buffer controller 203 may determine the output time of the first buffer 201 to transmit the main image to the first decoder 204 and the output time point of the second buffer 202 to transmit the additional image to the second decoder 205. For example, the buffer controller 203 may extract a timestamp of a frame of a main image stored last in the first buffer 201. The buffer controller 203 may extract a timestamp of a frame of an additional image stored last in the second buffer 202.

Here, the buffer controller 203 may extract a PTS of a first frame among a GOP of an ATSC main stream of the main image stored last in the first buffer 201. Further, the buffer controller 203 may extract an RTP timestamp of a first frame among a GOP of an M/H stream of the additional image stored last in the first buffer 202.

Here, a PTS is a 33-bit timestamp loaded onto a PES header and transmitted so as to synchronize presentation times of an audio/video AU in an ATSC main broadcast network. Here, a PES is a packet obtained by dividing each ES into a predetermined length for transmitting an audio/video ES in the ATSC main broadcast network. Here, the PES header includes a PTS. An RTP is a standard for transmitting audio/video data over an Internet Protocol (IP).

The buffer controller 203 compares the RTP timestamp converted based on the PCR with PTS %2̂32 on the basis of information about timestamps, an RTP timestamp and a PTS, extracted from AUs input last to the first buffer unit 210 and the second buffer unit 202, thereby determining the buffer delay times of the first buffer unit 201 and the second buffer unit 202. For example, when the RTP timestamp converted based on the PCR is smaller by 180,000 than PTS %2̂32, the RTP timestamp-based right image stream is received faster by a time of 180,000 (difference)/90,000 (clock rate) than the PTS-based left image stream. Thus, the buffer controller 203 may store the right image stream in the second buffer 202 for 2 seconds and then output the right image stream to the second decoder 205, thereby simultaneously transmitting ESs of the left image stream and the right image stream to the first decoder 204 and the second decoder 205.

FIG. 6 illustrates a process of correcting a reference clock or a timestamp according to an exemplary embodiment of the present invention.

Referring to FIG. 6, T1 represents a time at which an AU (AU1) of a left image stream arrives and T2 represents a time at which an AU (AU1) of a right image stream arrives. Δt is T2-T1. In FIG. 6, T2 is greater than T1, which means that the left image stream arrives in the image reproduction apparatus 102 before the right image stream. Meanwhile, suppose that a reference clock is signaled through a transmission network for the left image stream.

Then, the reference clock may be corrected by Equation 2.

Reference Clock Y=Reference cClock X−(Δt*clock_rate) [Equation 2]

Here, Reference Clock Y is a corrected reference clock, and Reference Clock X is an original reference clock. According to Equation 2, the image reproduction apparatus 102 that provides a 3DTV service may use Reference Clock Y obtained by subtracting a result of combination of a reception time difference and a clock rate from Reference Clock X. For instance, when Reference Clock X is 127,000,000, the reception time difference is 1 second, and the clock rate of the reference clock is 27,000,000 Hz, the image reproduction apparatus 102 may use Reference Clock Y=127,000,000−27,000,000=100,000,000, obtained by correcting the PCR as Reference Clock X into a reference clock 1 second ago.

According to Equation 2, a reference clock representing T2 is corrected into a reference clock T1. That is, when a reference clock is corrected, the reference clock is delayed for a period of time until one of the image streams arrives after the other thereof arrives.

A PTS, a DTS or an RTP timestamp to indicate the presentation time of the right image stream may be changed into a form that uses the reference clock of the left image stream using the signaled synchronization information. Time information and the corrected reference clock of the changed right image stream may be used to decode and output the right image stream. For example, since the timestamp of the AU 1 of the right image stream is converted into T1, the AU1 of the right image stream may be presented at the same time point as the AU1 of the left image stream. Meanwhile, when T1 is greater than T2, the right image stream is already stored in the buffer at a time point when the left image stream arrives, and thus correction of the reference clock may not be needed.

Meanwhile, when correcting a timestamp is used to deal with a reception delay instead of correcting a reference clock, the timestamps of the left and right images may be corrected by Equation 3.

Frame Time Information Y=Frame Time Information X+(Δt*clock_rate) [Equation 3]

Here, Frame Time Information Y is a corrected timestamp, and Frame Time Information X is an original timestamp. When a timestamp is corrected instead of a reference clock, a transmitted reference clock may be used as it is. In detail, all timestamps related to the AUs of the left image stream and the right image stream, for example, the PTS, the DTS and the RTP timestamp, may need correcting by addition by the reception time difference. For example, when the reception time difference is 1 second and a PTS, a DTS and an RTP timestamp of a video stream all have a clock rate of 90,000 Hz, the image reproduction apparatus 102 may use a timestamp corrected by adding 90,000 to the original timestamps.

In the correction of the timestamp in FIG. 6, frame time information representing T1 is corrected into T2. That is, when frame time information is corrected, the frame time information is delayed for a period of time until one of the image streams arrives after the other thereof arrives. As described above, a PTS, a DTS or an RTP timestamp as frame time information about the right image stream may be changed into a form that uses the reference clock of the left image stream using the signaled synchronization information. The changed timestamp and the original reference clock, which is the reference clock of the left image stream, may be used to decode and output the right image stream. Here, the original reference clock is the reference clock of the left image stream. When T1 is greater than T2, the right image stream is already stored in the buffer at a time point when the left image stream arrives, and thus correction of the frame time information may not be needed.

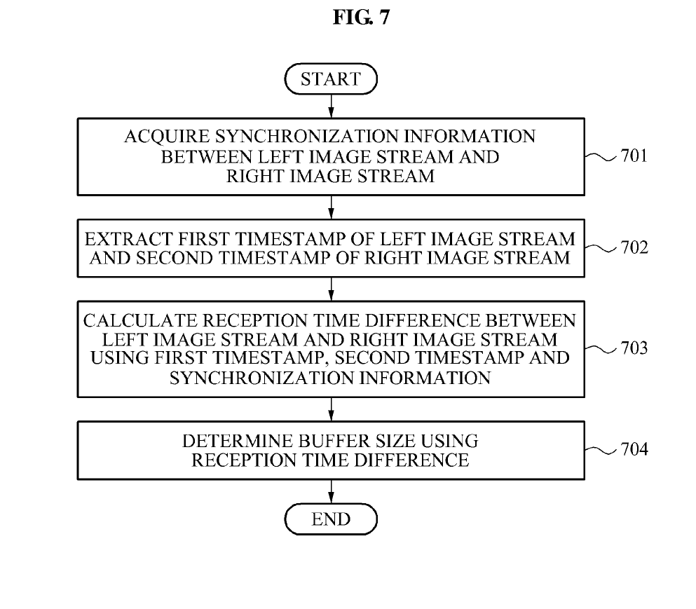

FIG. 7 is a flowchart illustrating a process of controlling a buffer size according to an exemplary embodiment of the present invention.

In operation 701, the image reproduction apparatus 102 may acquire synchronization information between a left image stream and a right image stream. For example, the image reproduction apparatus 102 may acquire synchronization information including timestamp pair information including a first timestamp of the left image stream and a second timestamp of the right image stream to be presented simultaneously at an arbitrary point of time. The image reproduction apparatus 102 may acquire synchronization information including offset information between the first timestamp of the left image stream and the second timestamp of the right image stream.

In operation 702, the image reproduction apparatus 102 may extract the first timestamp of the left image stream and the second timestamp of the right image stream. For example, the image reproduction apparatus 102 may extract the first timestamp and the second timestamp based on an AU of the left image stream and an AU of the right image stream received at the same time point. Alternatively, the image reproduction apparatus 102 may extract the first timestamp of the left image stream and the second timestamp of the right image stream extracted at similar time points by demultiplexing.

In operation 703, the image reproduction apparatus 102 may calculate a reception time difference between the left image stream and the right image stream using the first timestamp, the second timestamp and the synchronization information. For instance, when the left image stream and the right image stream use the same reference clock, the image reproduction apparatus 102 may calculate the reception time difference using a timestamp difference between the first timestamp and the second timestamp. When the left image stream and the right image stream use different reference clocks or a random offset is applied, the image reproduction apparatus 102 may convert one of the first timestamp and the second timestamp using the synchronization information and calculate the reception time difference using the timestamp difference between the first timestamp and the second timestamp.

In operation 704, the image reproduction apparatus 102 may determine a buffer size using the reception time difference. For instance, the image reproduction apparatus 102 may calculate a number of frames delayed between the left image stream and the right image stream using a number of AUs stored in a buffer, the reception time difference and frame rates of the image streams and determine the buffer size dynamically set up based on the calculated number of frames. Alternatively, the image reproduction apparatus 102 may determine the buffer size using a constant bit rate of the left image stream or the right image stream and the reception time difference. Alternatively, the image reproduction apparatus 102 may determine the buffer size using a data rate of the left image stream or the right image stream and the reception time difference.

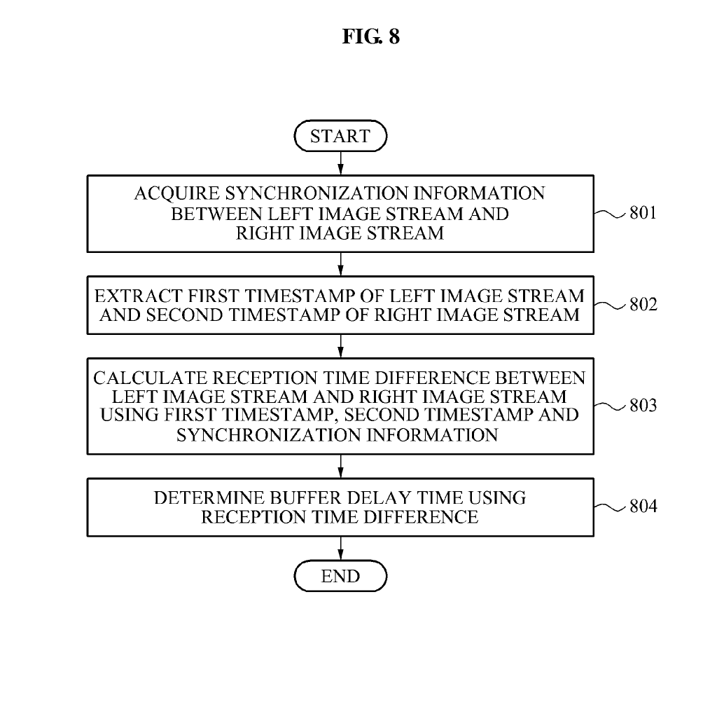

FIG. 8 is a flowchart illustrating a process of determining a buffer delay time according to an exemplary embodiment of the present invention.

In operation 801, the image reproduction apparatus 102 may acquire synchronization information between a left image stream and a right image stream. For instance, the image reproduction apparatus 102 may. For instance, the image reproduction apparatus 102 may acquire synchronization information including timestamp pair information including a first timestamp of the left image stream and a second timestamp of the right image stream to be presented simultaneously at an arbitrary point of time. The image reproduction apparatus 102 may acquire synchronization information including offset information between the first timestamp of the left image stream and the second timestamp of the right image stream.

In operation 802, the image reproduction apparatus 102 may extract the first timestamp of the left image stream and the second timestamp of the right image stream. For example, the image reproduction apparatus 102 may extract the first timestamp and the second timestamp based on an AU of the left image stream and an AU of the right image stream received at the same time point. Alternatively, the image reproduction apparatus 102 may extract the first timestamp of the left image stream and the second timestamp of the right image stream extracted at similar time points by demultiplexing.

In operation 803, the image reproduction apparatus 102 may calculate a reception time difference between the left image stream and the right image stream using the first timestamp, the second timestamp and the synchronization information. For instance, when the left image stream and the right image stream use the same reference clock, the image reproduction apparatus 102 may calculate the reception time difference using a timestamp difference between the first timestamp and the second timestamp. When the left image stream and the right image stream use different reference clocks or a random offset is applied, the image reproduction apparatus 102 may convert one of the first timestamp and the second timestamp using the synchronization information and calculate the reception time difference using the timestamp difference between the first timestamp and the second timestamp.

In operation 804, the image reproduction apparatus 102 may determine a buffer delay time using the reception time difference. For instance, when the left image stream is received before the right image stream, the image reproduction apparatus 102 may increase a buffer delay time of the right image stream by the reception time difference. When the right image stream is received before the left image stream, the image reproduction apparatus 102 may increase a buffer delay time of the left image stream by the reception time difference.

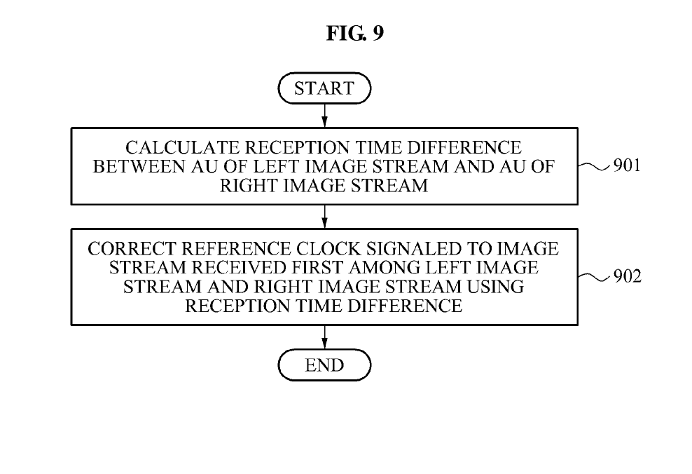

FIG. 9 is a flowchart illustrating a process of correcting a reference clock according to an exemplary embodiment of the present invention.

In operation 901, the image reproduction apparatus 102 may calculate a reception time difference between an AU of a left image stream and an AU of a right image stream.

In operation 902, the image reproduction apparatus 102 may correct a reference clock signaled to one of the left image stream and the right image stream that is received before the other thereof using the reception time difference. For instance, the image reproduction apparatus 102 may correct the reference clock using a result of applying the reception time difference to a clock rate of the reference clock.

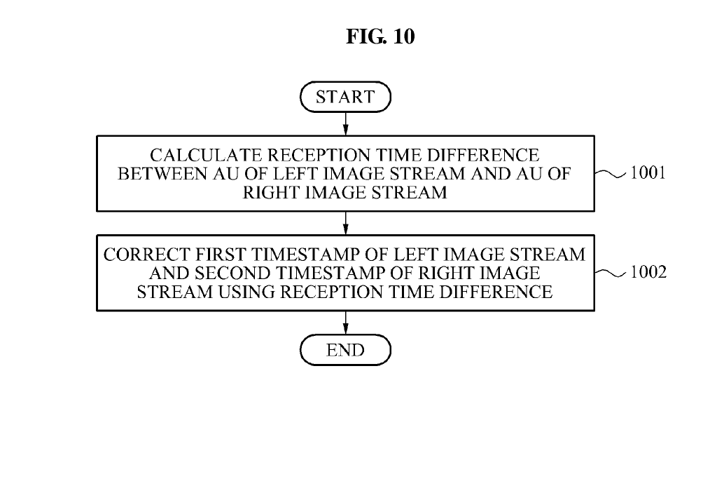

FIG. 10 is a flowchart illustrating a process of correcting a timestamp according to an exemplary embodiment of the present invention.

In operation 1001, the image reproduction apparatus 102 may calculate a reception time difference between an AU of a left image stream and an AU of a right image stream.

In operation 1002, the image reproduction apparatus 102 may correct a first timestamp of the left image stream and a second timestamp of the right image stream using the reception time difference. For instance, the image reproduction apparatus 102 may correct the first timestamp of the left image stream and the second timestamp of the right image stream using a result of applying the reception time difference to a clock rate of a reference clock.

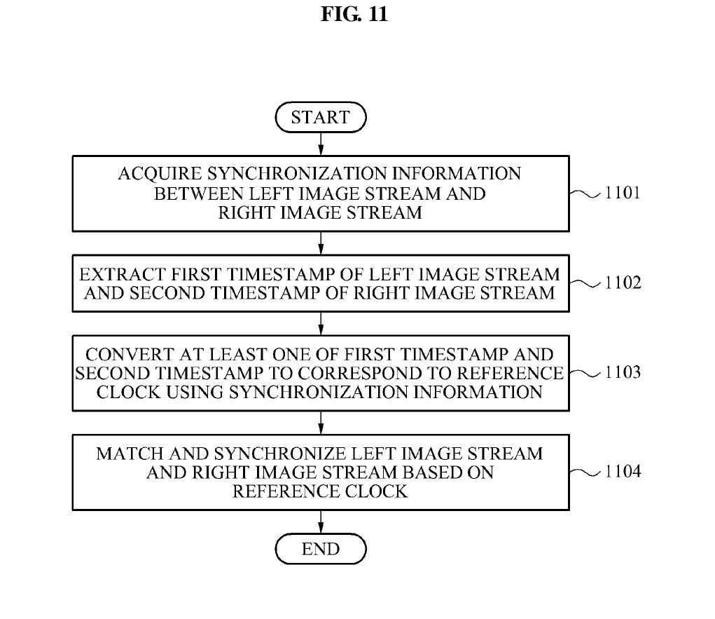

FIG. 11 illustrates a process of synchronizing a left image stream and a right image stream according to an exemplary embodiment of the present invention.

In operation 1101, the image reproduction apparatus 102 may acquire synchronization information between a left image stream and a right image stream.

In operation 1102, the image reproduction apparatus 102 may extract a first timestamp of the left image stream and a second timestamp of the right image stream.

In operation 1103, the image reproduction apparatus 102 may convert at least one of the first timestamp and the second timestamp to correspond to a reference clock using the synchronization information.

In operation 1104, the image reproduction apparatus 102 may match and synchronize the left image stream and the right image stream based on the reference clock.

The methods according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A buffer control method of an image reproduction apparatus, the buffer control method comprising:
acquiring synchronization information between a left image stream and a right image stream;
extracting a first timestamp of the left image stream and a second timestamp of the right image stream;
calculating a reception time difference between the left image stream and the right image stream using the first timestamp, the second timestamp and the synchronization information; and
determining a buffer size using the reception time difference.

2. The buffer control method of claim 1, wherein the acquiring of the synchronization information acquires synchronization information comprising timestamp pair information comprising the first timestamp of the left image stream and the second timestamp of the right image stream to be presented simultaneously at a an arbitrary point of time.

3. The buffer control method of claim 1, wherein the acquiring of the synchronization information acquires synchronization information comprising offset information between the first timestamp of the left image stream and the second timestamp of the right image stream.

4. The buffer control method of claim 1, wherein the extracting of the first timestamp of the left image stream and the second timestamp of the right image stream extracts the first timestamp and the second timestamp based on an access unit (AU) last stored among an AU of the left image stream and an AU of the right image stream received at the same time point.

5. The buffer control method of claim 1, wherein the extracting of the first timestamp of the left image stream and the second timestamp of the right image stream extracts the first timestamp of the left image stream and the second timestamp of the right image stream extracted by demultiplexing at similar time points.

6. The buffer control method of claim 1, wherein the calculating of the reception time difference calculates a reception time difference using a timestamp difference between the first timestamp and the second timestamp when the left image stream and the right image stream use the same reference clock, and converts one of the first timestamp and the second timestamp using the synchronization information and calculates a reception time difference using the timestamp difference between the first timestamp and the second timestamp when the left image stream and the right image stream use different reference clocks or a random offset is applied.

7. The buffer control method of claim 1, wherein the determining of the buffer size calculates a number of frames delayed between the left image stream and the right image stream using a number of AUs stored in a buffer, the reception time difference and frame rates of the image streams and determines the buffer size dynamically set up based on the calculated number of frames.

8. The buffer control method of claim 1, wherein the determining of the buffer size determines the buffer size using a constant bit rate of the left image stream or the right image stream and the reception time difference.

9. The buffer control method of claim 1, wherein the determining of the buffer size determines the buffer size using a data rate of the left image stream or the right image stream and the reception time difference.

10. A buffer control method of an image reproduction apparatus, the buffer control method comprising:
acquiring synchronization information between a left image stream and a right image stream;
extracting a first timestamp of the left image stream and a second timestamp of the right image stream;
calculating a reception time difference between the left image stream and the right image stream using the first timestamp, the second timestamp and the synchronization information; and
determining a buffer delay time using the reception time difference.

11. The buffer control method of claim 10, wherein the determining of the buffer delay time increases a buffer delay time of the right image stream by the reception time difference when a right image stream is received before a left image stream, and increases a buffer delay time of the left image stream by the reception time difference when the left image stream is received before the right image stream.

12. A clock correction method of an image reproduction apparatus, the clock correction method comprising:
calculating a reception time difference between an access unit (AU) of a left image stream and an AU of a right image stream; and
correcting a reference clock signaled to one of the left image stream and the right image stream that is received before the other thereof using the reception time difference.

13. The clock correction method of claim 12, wherein the correcting of the reference clock corrects the reference clock using a result of applying the reception time difference to a clock rate of the reference clock.

14. A timestamp correction method of an image reproduction apparatus, the timestamp correction method comprising:
calculating a reception time difference between an access unit (AU) of a left image stream and an AU of a right image stream; and
correcting a first timestamp of the left image stream and a second timestamp of the right image stream using the reception time difference.

15. The timestamp correction method of claim 14, wherein the correcting of the first timestamp of the left image stream and the second timestamp of the right image stream corrects the first timestamp of the left image stream and the second timestamp of the right image stream using a result of applying the reception time difference to a clock rate of a reference clock.

16. A synchronization method of an image reproduction apparatus, the synchronization method comprising:
acquiring synchronization information between a left image stream and a right image stream;
extracting a first timestamp of the left image stream and a second timestamp of the right image stream;
converting at least one of the first timestamp and the second timestamp to correspond to a reference clock using the synchronization information; and
matching and synchronizing the left image stream and the right image stream based on the reference clock.

17. An image reproduction apparatus comprising:
a first buffer to receive and store a left image stream;
a second buffer to receive and store a right image stream; and
a buffer controller to determine buffer sizes of the first buffer and the second buffer using a reception time difference between the left image stream and the right image stream,
wherein the reception time difference is determined based on a first timestamp of the left image stream, a second timestamp of the right image stream and synchronization information between the left image stream and the right image stream.

18. An image reproduction apparatus comprising:
a first buffer to receive and store a left image stream;
a second buffer to receive and store a right image stream; and
a buffer controller to determine a buffer delay time of the first buffer or the second buffer using a reception time difference between the left image stream and the right image stream,
wherein the reception time difference is determined based on a first timestamp of the left image stream, a second timestamp of the right image stream and synchronization information between the left image stream and the right image stream.

19. An image reproduction apparatus comprising:
a first buffer to receive and store a left image stream;
a second buffer to receive and store a right image stream; and
a buffer controller (i) to correct a reference clock signaled to one of the left image stream and the right image stream that is received before the other thereof or (ii) to correct a first timestamp of the left image stream and a second timestamp of right image stream using a reception time difference between an access unit (AU) of the left image stream and an AU of the right image stream.

20. An image reproduction apparatus comprising:
a first buffer to receive and store a left image stream;
a second buffer to receive and store a right image stream; and
an image synchronization unit to convert at least one of a first timestamp of the left image stream and a second timestamp of the right image stream according to a reference clock using synchronization information between the left image stream and the right image stream and to match and synchronize the left image stream and the right image stream based on the reference clock.
